(19) United States
(12) Patent Application Publication
(10) Pub. No.: US 2023/0148573 A1
(43) Pub. Date: May 18, 2023

(54) Relocatable Aquafarming System

(71) Applicant: Forever Oceans Corporation, Bethesda, MD (US)

(72) Inventors: Ross Gordon, Aldgate (AU); Mathew Goldsborough, Kamuela, HI (US); Anthony White, Kailua Kona, HI (US)

(21) Appl. No.: 18/099,561

(22) Filed: Jan. 20, 2023

Related U.S. Application Data
(63) Continuation-in-part of application No. 15/551,143, filed on Aug. 15, 2017, now Pat. No. 11,559,046.
(60) Provisional application No. 62/118,171, filed on Feb. 19, 2015.

(51) Int. Cl. A01K 61/65; A01K 61/80

(52) U.S. Cl. CPC A01K 61/65; A01K 61/80; A01K 2227/40

(57) ABSTRACT

A movable aquafarming system is provided, including a vessel and a plurality of connected fish pens. The plurality of fish pens are arranged in a line, with a first fish pen of the plurality of fish pens being disposed closest to the vessel. The vessel is configured to be moored, and when moored the first fish pen is attached proximate to the vessel, and when the vessel is not moored the first fish pen is configured to attach to the vessel with a length of a tow line, whereby the vessel can tow the plurality of fish pens to a different location.

### CROSS-REFERENCE TO RELATED APPLICATIONS

This application is a Continuation-In-Part of U.S. patent application Ser. No. 15/551,143 filed Aug. 15, 2017 which is a national stage entry of PCT/US2016/018445 filed Feb. 18, 2016, and which also claims priority to U.S. Provisional Application No. 62/118,171, filed Feb. 19, 2015, the disclosures of all three are incorporated herein by reference.

### BACKGROUND OF THE INVENTION

### Field of the Invention

The invention relates generally to the field of aquaculture and more particularly to aquafarming systems for open water operations.

### Description of the Prior Art

Fish farming has been performed since ancient times. Traditionally, this has been accomplished in near-shore regions, where a grid of tensioned lines can be readily maintained between permanent moorings to support one or more fish pens. Feeding and other husbandry tasks are then performed by personnel that move between fish pens in support vessels. However, near-shore fish farming creates a number of problems including polluted coastal waters.

To mitigate these problems, open-water aquafarming situated out to sea away from coastal waters has been developed. Managing and operating such open ocean aquaculture systems is fraught with very difficult and dangerous tasks. Day to day husbandry functions, such as feeding the fish, cleaning the pens or monitoring the environment, require teams to make daily trips to the offshore pens. When fairly close to shore (e.g., <5 nm) operators may spend upwards of two hours of idle time a day traveling back and forth to the offshore aquafarm. As commercial aquafarms grow, the distance from shore and the size of the cages will increase dramatically, increasing inefficiencies in this conventional model, reducing the profitability of the farm.

### SUMMARY

The present disclosure provides an exemplary movable aquafarming system comprising a vessel and a plurality of connected fish pens. Each fish pen includes netting enclosing a volume of seawater, and the plurality of fish pens are arranged in a line, with a first fish pen of the plurality of fish pens being disposed closest to the vessel. The vessel is configured to be moored, such as with an anchor, and when moored the first fish pen is attached proximate to the vessel, and when the vessel is not moored the first fish pen is configured to attach to the vessel with a length of a tow line, whereby the vessel can tow the plurality of fish pens to a different location. In some embodiments, when the system is moored, the first fish pen is attached to the vessel by a fender, such as a pneumatic-type fender, or a crow's foot arrangement of lines, and when the system is unmoored, the first fish pen is attached to the vessel by a tow line. In some of these embodiments, a crow's foot arrangement of lines attaches the first fish pen to the tow line. In further embodiments the exemplary aquafarming system further comprising a feeding system for transporting feed from the vessel to each of the fish pens and that can continue to deliver feed while the system is in transit.

An exemplary method for moving an aquafarming system comprises unmooring a vessel of the aquafarming system, where the aquafarming system includes the vessel attached to a plurality of connected fish pens. The exemplary method further comprises disposing a tow line between the vessel and a first fish pen of the plurality of fish pens and using the vessel to tow the plurality of fish pens to a different location. Then the method comprises mooring the vessel at the different location.

In some embodiments, the step of disposing the tow line between the vessel and the first fish pen includes disconnecting a crow's foot arrangement of lines attaching the first fish pen from a stern of the vessel, and connecting the tow line to the crow's foot arrangement of lines. In various embodiments the exemplary method further comprises determining that the aquafarming system needs to be relocated, before unmooring the vessel. In still other embodiments the exemplary method further comprises delivering feedstock to the plurality of fish pens while under tow.

### BRIEF DESCRIPTION OF DRAWINGS

FIG. 1 is a high-level system architecture where multiple aquafarms are accessible to operators through cloud services, according to an exemplary embodiment.

FIG. 2 illustrates an exemplary embodiment of an aquafarm utilizing multiple network adapters to provide redundant network links.

FIG. 3 is a high-level data cloud services architecture, according to an exemplary embodiment.

FIG. 4 illustrates multiple ways a user can connect to, monitor and control an aquafarm, according to exemplary embodiments.

FIGS. 5A and 5B are a top and side views, respectively, of an aquafarming system while moored, according to exemplary embodiments.

FIG. 5C is a top view of the moored aquafarming system of FIGS. 5A and 5B, providing a more detailed illustration of the vessel and fish pens thereof.

FIG. 5D is a top partial view of another exemplary aquafarming system showing an alternative attachment from the vessel to the first fish pen.

FIG. 6 is a top view of an exemplary embodiment of an aquafarming system unmoored and in transit.

### DETAILED DESCRIPTION

Most conventional husbandry functions involve a wide array of analog pumps and motors in various configurations. These devices need to be turned on and off in a specific way to accomplish the day's tasks without damaging the equipment or the fish. Operators are required to be physically next to the equipment, constantly monitoring the system for signs of fault or defects. Other husbandry functions include monitoring the water quality in and around the aquafarm by taking samples from multiple locations, a time consuming operation.

The inability to reliably communicate with aquaculture systems and automate labor intensive tasks is a significant barrier to scalable aquaculture systems.

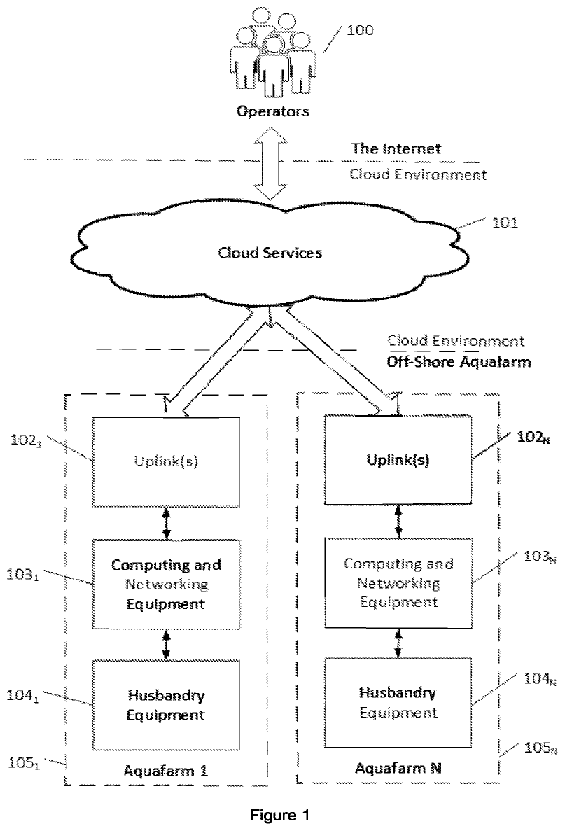

As illustrated in the example of FIG. 1, operators 100 are able to communicate and interact with the offshore aquafarm 105 and associated husbandry equipment 104 through managed cloud services 101. Husbandry functions provided include, but are not limited to, feeding fish, harvesting fish, cleaning the aquaculture cage and removing mortalities from the aquaculture cage. Cloud services 101 may aggregate aquafarms 105 into a single cloud environment allowing operators 100 to monitor and control one or more aquafarms 105 simultaneously.

According to certain embodiments of the invention, one or more uplinks 102 provide network computing and networking equipment 103 connectivity to cloud services 101. Networking and computing equipment may include firewalls, embedded computers, switches, Internet Protocol (IP) enabled cameras and other network enabled devices which facilitate the secure, reliable monitoring, and command and control (C2) of husbandry equipment 104 installed on the offshore aquafarm 105. On-board computing and networking equipment 103 may communicate directly with husbandry equipment 104 through standardized protocols, such as Transmission Control Protocol (TCP), or indirectly through an electro-mechanical device which supports a protocol like TCP.

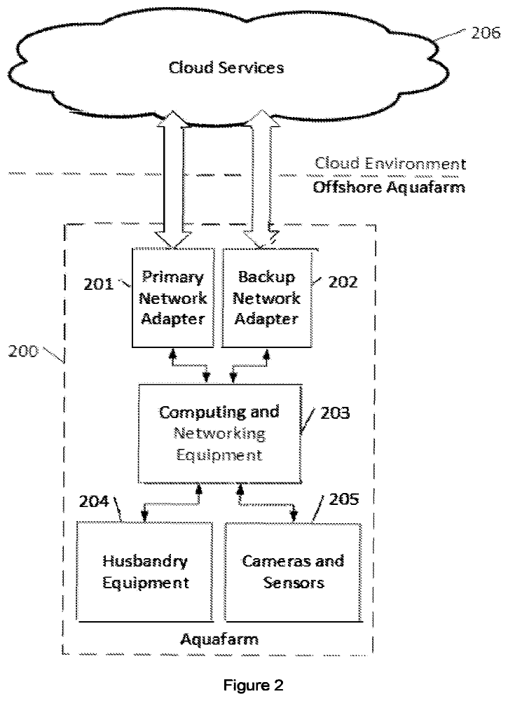

FIG. 2 illustrates an embodiment which utilizes two adapters 202 which serve as the uplinks 102 for the aquafarm. According to an embodiment, to guarantee network connectivity, a primary network adapter 201 is used in conjunction with a backup network adapter 202. In one embodiment, the network adapters are configured to provide high-availability (HA) wherein if the primary network adapter 201 fails it will result in network traffic being routed through the backup network adapter 202. In another embodiment, the network adapters are configured in parallel allowing network traffic to flow through either the primary network adapter 201 or the backup network adapter 202. The computing and networking equipment may detect congestion through the primary network adapter 201 and choose to route traffic through the secondary network adapter 202, thus aggregating the bandwidth available for network communications. The network adapters may leverage high-bandwidth communication technologies such as Wi-Fi as well as lower bandwidth technologies such as cellular networks or DSL.

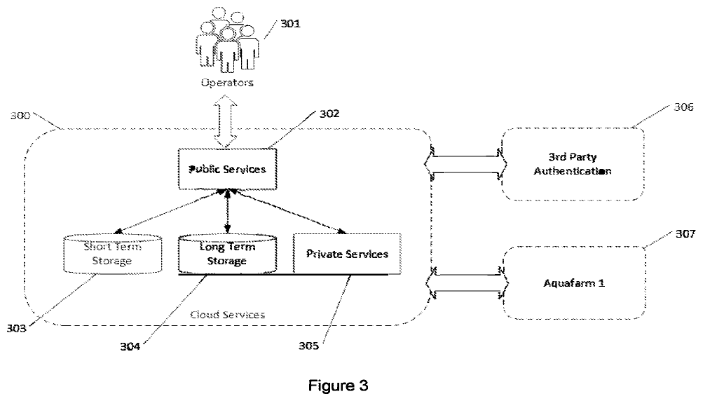

FIG. 3 illustrates a high level architecture embodiment of the cloud services 300 and the external actors it may interact with. Cloud services 300 may leverage an Infrastructure as a Service (IaaS) provider or Platform as a Service (PaaS) provider to manage computing resources such as processing power and network bandwidth. In another embodiment, the cloud services 300 are self-hosted in a managed data center. A self-hosted managed data center, or elements thereof, can be located offshore, in some embodiments, such as on a vessel of the offshore aquafarm 105. Public services 302 may host a web application which can be accessed securely by operators 301 through a variety of means. Additionally, public services 302 may expose an Application Programming Interface (API) to operators 302 providing data and C2 resources in industry standard formats such as JavaScript Object Notation (JSON) or Extensible Markup Language (XML).

Gaining access to the cloud services may be accomplished by checking operator 301 provided credentials against expected values stored in a short term storage database 303. In another embodiment, a 3rd party authentication mechanism 306 such as an external Active Directory, OAuth or OpenID may be used to authenticate user and ensure security.

Through network segmentation, virtual private network (VPN) or otherwise, private services 305 can be secured to only allow access from the aquafarm 307. Similarly, the aquafarm 307 may be configured through a firewall, network configuration or otherwise, to limit connectivity to allowed private services 305 and nothing more. In one embodiment, private services may 305 reach out to the aquafarm 307 to initiate and maintain a network link providing a route from an aquafarm 307 to other cloud services 300. In yet another embodiment, the aquafarm 307 may initialize and maintain a secure connection to various services hosted in the cloud 300.

Data storage requirements may be satisfied through two mechanisms. Short term storage 303 may provide, among other things, instantaneous access to the most recent volatile data which has been received by the system. An example of short term storage 303 may be an in-memory cache. Long term storage 304 may provide slower access to non-volatile memory allowing data to be persisted to disk and saved for later use. Storage services may be provided by conventional database packages, such as MS SQL or MongoDB, and stored directly onto the hard drive. Other embodiments may include the use cloud based object storage provided by an IaaS such as Amazon Web Services.

Depending on the embodiment of this disclosure, the cloud services 300 may exist on one or many computing devices. In one embodiment, each service may exist on its own computing devices with its own dedicated resources. According to another embodiment, all of the components which make up the cloud services 300 may exist on a single computing device where resources (hard drive, memory, etc.) are shared among the services.

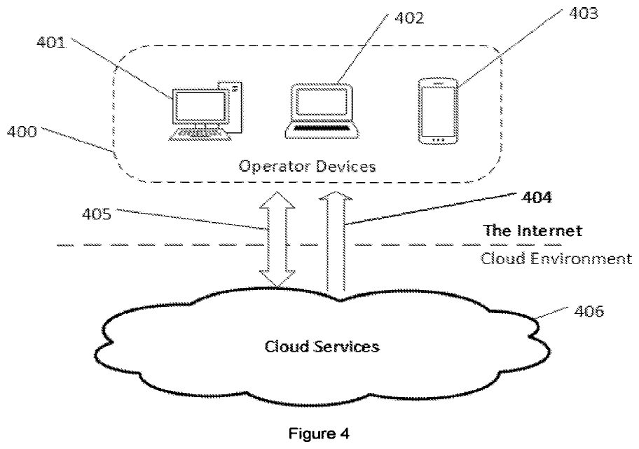

FIG. 4 illustrates examples of the many ways an operator 400 may access cloud services 406 provided by this disclosure. In one embodiment, an operator 400 may access cloud services 406 and thereby one or many aquafarms, through a web browser installed on a desktop computer 401. Additional embodiments include access to cloud services 406 through a web browser installed on a laptop computer 402 or a smartphone 403. This access to services is preserved when a user is collocated with a farm system, in the event of loss of (long-range) cloud connection. Offshore computing resources host the data viewing and control elements for the system, preserving local control when out of range.

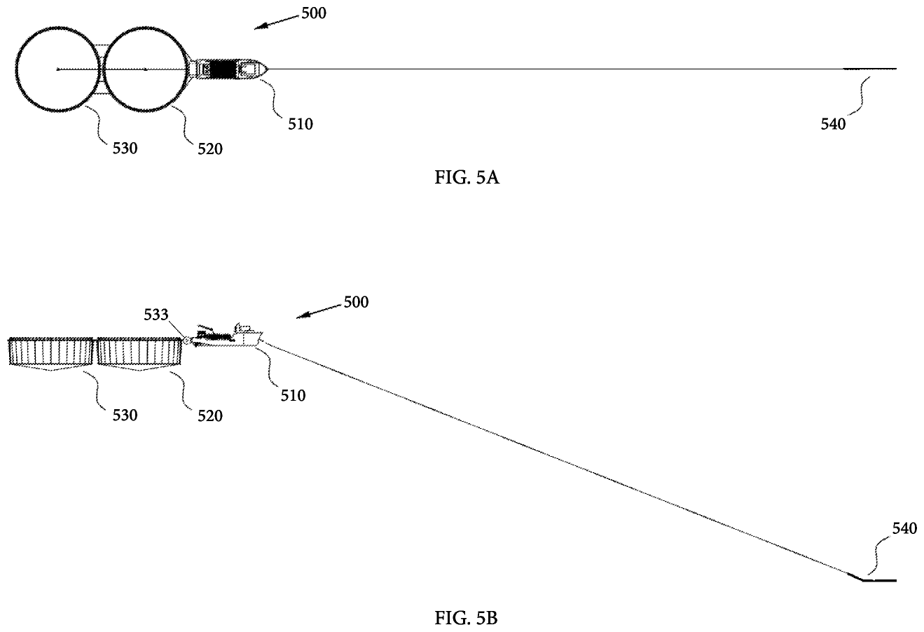

FIGS. 5A and 5B illustrate, respectively, top and side views of an exemplary embodiment of an aquafarm 105, in this example a relocatable aquafarming system 500 comprising a vessel 510 and fish pens 520 and 530. FIG. 5C shows an enlarged view of the vessel 510 and fish pens 520, 530. The fish pen 520 closest to the vessel 510 is designated as the first fish pen 520. The vessel 510 is configured to be readily moored and unmoored from the seafloor, such as with an anchor, in open water where the depth ranges from about 100 meters to about 1000 meters. When the vessel 510 is moored, as shown in FIGS. 5A and 5B, the first fish pen 520 is attached with less than 10 meters separation to the vessel 510, and the fish pen 530 is attached proximate to the first fish pen 520. Additional fish pens 530 can be added such that all fish pens 520, 530 are arranged in a line. That is, the centers of the fish pens 520, 530 are approximately colinear. This arrangement facilitates towing the fish pens 520, 530 to different locations. The linear arrangement serves to reduce drag and simplify dynamic forces required to keep the pens positioned relative to one another.

Vessel 510 is a ship suitable for the seas in which it will be used, with storage capacity for fish feedstock sufficient for multiple days as well as husbandry equipment 104 including equipment to deliver feedstock to the fish pens 520, 530 from the vessel 510. The vessel 510 includes a means 540 to moor in open waters, such as an anchor or a suction caisson. The vessel 510 optionally includes the computing and networking equipment 103 described above, and crew's quarters.

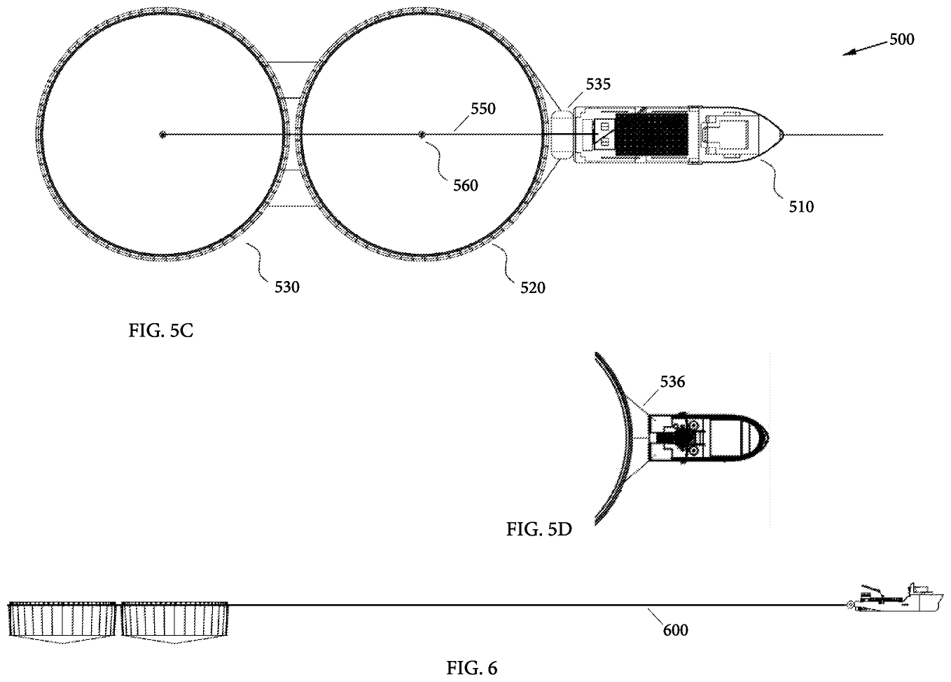

When the vessel 510 is not moored, the first fish pen 520 is configured to attach to the vessel with a length of a tow line 600, as shown in the top view of FIG. 6, in order to put greater separation between the vessel 510 and the fish pens 520, 530 for greater towing efficiency. The first fish pen 520, when the vessel 510 is moored, is attached to the vessel 510 by way of a fender 533 such as a pneumatic-type fender. In other embodiments, as illustrated by FIG. 5D, a crow's foot grouping of lines 536 attaches the first fish pen 520 to the vessel 510. Further embodiments employ both, with a crow's foot 536 attaching the fish pen 520 to the fender 533 which is attached to the vessel 510. The first fish pen 520 can be attached to the next fish pen 530 with a plurality of lines, as can any successive fish pens 530. When a tow line 600 is employed, one end of the tow line 600 can connect to the crow's foot 536 in order to spread the tow force across the bow of the fish pen 520. A suitable tow line length is about 200 to 300 meters or more. A tow line with a 75T working load tension specification is sufficient to tow two fish pens 520, 530 at a speed of 1 knot.

In various embodiments the vessel 510 is moored by a mooring system that can moor the aquafarming system 500 against all external environmental forces. In other embodiments the mooring system is configured to moor the vessel 510 up to some maximum load, beyond which the aquafarming system 500 may be set adrift. In operation, the aquafarming system 500 may be unmoored, towed to a new location, and moored again. The aquafarming system 500 can be towed to a different location for regular tasks such as crew rotations, restocking consumables, juvenile fish stocking, grading, and/or harvest operations. The aquafarming system 500 can also be moved to avoid such hazards as oil spills, algal blooms, and large storm systems. Decisions to relocate the aquafarming system 500 can be based on situational awareness of relevant environmental and aquaculture logistical constraints drawn from meteorological conditions and forecasts, satellite imagery, and aquaculture models. In some embodiments, a computing system such as computing and networking equipment 103 is utilized to process incoming data to automatically alert operators when the aquafarming system 500 should be relocated. The computing system can also recommend new mooring locations as well as transit paths, in some embodiments. In various embodiments the tow speed is on the order of one knot or less.

Each fish pen 520, 530 can include a number of devices for performing husbandry tasks, for example, cameras, water quality monitoring, wireless communications systems, and tethered Remotely Operated Vehicles (ROVs) for mortality handling or general inspection purposes. In many embodiments these devices are powered by renewable energy sources. Data and control of these systems can be facilitated by a cloud aquaculture management system such as cloud services 100, 300.

In operation, when a decision has been made to relocate the aquafarming system 500, excess mooring line is taken up, such as by hand, until the vessel 510 is situated approximately over the mooring location. Next, where the mooring is an anchor, a winch or bollard is used to raise the anchor to the vessel 510. Before, after, or concurrently with the unmooring of the vessel 510, the first fish pen 520 is disconnected from the stern of the vessel 510 and the tow line is attached to the first fish pen 520. A sufficient length of tow line is then paid out, such as by hand. The aquafarming system 500 is then ready for movement to a new location. Once in the new location the vessel 510 is moored, the tow line is brought in, and the stern of the vessel 510 is reattached to the first fish pen 520 using the crow's foot. It should be noted that some or all of the husbandry devices such as cameras and sensors continue to operate as the aquafarming system 500 is moved to the new location.

Each fish pen 520, 530 includes a netting that encloses a volume of seawater within which fish are nurtured and harvested. The aquafarming system 500 is configured, in some embodiments, to store and deliver feedstock, even while the aquafarming system 500 is in transit. Control of the feed delivery may come from a number of sources, including manual operator control, automatic control based on biological cohort state, or some combination. The timing, frequency, rate of delivery, duration and total feedstock delivered are both controlled and automatically recorded and communicated to the supporting aquaculture cloud infrastructure. Information on total feedstock mass, age, and condition is similarly communicated and displayed to relevant stakeholders in the aquaculture organization. In all embodiments feed, typically in the form of fish feed pellets, can be delivered over distances ranging from 40 to 350 meters from the vessel 510. Typically, one feed system is dedicated to one fish pen 520, 530. Each feed system mixes feed pellets in seawater in a mixer onboard the vessel 510 and injects the mixture into a delivery pipe 550 having a rotary feed spreader 560 at the distal end to distribute the feed radially. The feed can be distributing across the water's surface at 25% or more of each fish pen's top surface area. In some embodiments the feed delivery hoses used while the aquafarming system 500 is moored are replaced by extended length feed delivery hoses for transit.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A movable aquafarming system comprising:
a vessel; and
a plurality of connected fish pens, each fish pen including netting enclosing a volume of seawater, the plurality of fish pens being arranged in a line, a first fish pen of the plurality of fish pens being disposed closest to the vessel,
wherein the vessel is configured to be moored, and when moored the first fish pen is attached proximate to the vessel, and when the vessel is not moored the first fish pen is configured to attach to the vessel with a length of a tow line, whereby the vessel can tow the plurality of fish pens to a different location.

2. The movable aquafarming system of claim 1 wherein the vessel is configured to be moored with an anchor.

3. The movable aquafarming system of claim 1 wherein the vessel is configured to be unmoored automatically when a threshold load is exceeded.

4. The movable aquafarming system of claim 1 wherein, when the system is moored, the first fish pen is attached to the vessel by a crow's foot arrangement of lines.

5. The movable aquafarming system of claim 1 wherein, when the system is unmoored, the first fish pen is attached to the vessel by a tow line.

6. The movable aquafarming system of claim 5 wherein a crow's foot arrangement of lines attaches the first fish pen to the tow line.

7. The movable aquafarming system of claim 1 further comprising a feeding system for transporting feed from the vessel to each of the fish pens while the system is in transit.

8. The movable aquafarming system of claim 1 wherein, when the system is moored, the first fish pen is attached to the vessel by a fender.

9. A method for moving an aquafarming system comprising:
unmooring a vessel of the aquafarming system, wherein the aquafarming system includes the vessel attached to a plurality of connected fish pens;
disposing a tow line between the vessel and a first fish pen of the plurality of fish pens;
using the vessel to tow the plurality of fish pens to a different location; and
mooring the vessel at the different location.

10. The method of claim 9 further comprising determining that the aquafarming system needs to be relocated.

11. The method of claim 9 wherein disposing the tow line between the vessel and the first fish pen includes disconnecting a crow's foot arrangement of lines attaching the first fish pen from a stern of the vessel, and connecting the tow line to the crow's foot arrangement of lines.

12. The method of claim 9 further comprising delivering feedstock to the plurality of fish pens while under tow.
